(19) United States
(12) Patent Application Publication
(10) Pub. No.: US 2013/0166303 A1
(43) Pub. Date: Jun. 27, 2013

(54) ACCESSING MEDIA DATA USING METADATA REPOSITORY

(71) Applicants: Walter Chang, San Jose, CA (US); Michael J. Welch, Los Angeles, CA (US)

(72) Inventors: Walter Chang, San Jose, CA (US); Michael J. Welch, Los Angeles, CA (US)

(73) Assignee: ADOBE SYSTEMS INCORPORATED, San Jose, CA (US)

(21) Appl. No.: 12/618,353

(22) Filed: Nov. 13, 2009

(51) Int. Cl. G10L 13/00; G06F 17/30

(52) U.S. Cl. 704/258; 707/723; 707/706; 707/771; 707/765; 707/E17.109; 704/E13.001

(57) ABSTRACT

A computer-implemented method includes receiving, in a computer system, a user query comprising at least a first term, parsing the user query to at least determine whether the user query assigns a field to the first term, the parsing resulting in a parsed query that conforms to a predefined format, performing a search in a metadata repository using the parsed query, the metadata repository embodied in a computer readable medium and including triplets generated based on multiple modes of metadata for video content, the search identifying a set of candidate scenes from the video content, ranking the set of candidate scenes according to a scoring metric into a ranked scene list, and generating an output from the computer system that includes at least part of the ranked scene list, the output generated in response to the user query.

### BACKGROUND

This specification relates to accessing media data using a metadata repository.

Techniques exist for searching textual information. This can allow users to locate occurrences of a character string within a document. Such tools are found in word processors, web browsers, spreadsheets, and other computer applications. Some of these implementations extend the tool's functionality to provide searches for occurrences of not only strings, but format as well. For example, some “find” functions allow users to locate instances of text that have a given color, font, or size.

Search applications and search engines can perform indexing of content of electronic files, and provide users with tools to identify files that contain given search parameters. Files and web site documents can thus be searched to identify those files or documents that include a given character string or file name.

Speech to text technologies exist to transcribe audible speech, such as speech captured in digital audio recordings or videos, into a textual format. These technologies may work best when the audible speech is clear and free from background sounds, and some systems are “trained” to recognize the nuances of a particular user's voice and speech patterns by requiring the users to read known passages of text.

### SUMMARY

This specification describes technologies related to methods for performing searches of media content using a repository of multimodal metadata.

In a first aspect, a computer-implemented method comprises receiving, in a computer system, a user query comprising at least a first term, parsing the user query to at least determine whether the user query assigns a field to the first term, the parsing resulting in a parsed query that conforms to a predefined format, performing a search in a metadata repository using the parsed query, the metadata repository embodied in a computer readable medium and being generated based on multiple modes of metadata for video content, the search identifying a set of candidate scenes from the video content, ranking the set of candidate scenes according to a scoring metric into a ranked scene list, and generating an output from the computer system that includes at least part of the ranked scene list, the output generated in response to the user query.

Implementations can include any, all or none of the following features. The parsing may determine whether the user query assigns at least any of the following fields to the first term: a character field defining the first term to be a name of a video character; a dialog field defining the first term to be a word included in video dialog, an action field defining the first term to be a description of a feature in a video, and an entity field defining the first term to be an object stated or implied by a video. The parsing may comprise tokenizing the user query, expanding the first term so that the user query includes at least also a second term related to the first term, and disambiguating any of the first and second terms that has multiple meanings Expanding the first term may comprise performing an online search using the first term and identifying the second term using the online search, obtaining the second term from an electronic dictionary of related words, and obtaining the second term by accessing a hyperlinked knowledge base using the first term. Performing the online search may comprise entering the first term in an online search engine, receiving a search result from the online search engine for the first term, computing statistics of word occurrences in the search results, and selecting the second term from the search result based on the statistics.

Disambiguating any of the first and second terms may comprise obtaining information from the online search that defines the multiple meanings, selecting one meaning of the multiple meanings using the information, and selecting the second term based on the selected meaning Selecting the one meaning may comprise generating a context vector that indicates a context for the user query, entering the context vector in the online search engine and obtaining context results, expanding terms in the information for each of the multiple meanings, forming expanded meaning sets, entering each of the expanded meaning sets in the online search engine and obtaining corresponding expanded meaning results, and identifying one expended meaning result from the expanded meaning results that has a highest similarity with the context results.

Performing the search in the metadata repository may comprise accessing the metadata repository and identifying a matching set of scenes that match the parsed query, filtering out at least some scenes of the matching set, and wherein a remainder of the matching set forms the set of candidate scenes. The metadata repository may include triples formed by associating selected subjects, predicates and objects with each other, and wherein the method further comprises optimizing a predicate order in the parsed query before performing the search in the metadata repository. The method may further comprise determining a selectivity of multiple fields with regard to searching the metadata repository, and performing the search in the metadata repository based on the selectivity. The parsed query may include multiple terms assigned to respective fields, and wherein the search in the metadata repository may be performed such that the set of candidate scenes match all of the fields in the parsed query.

The method may further comprise, before performing the search, receiving, in the computer system, a script used in production of the video content, the script including at least dialog for the video content and descriptions of actions performed in the video content, performing, in the computer system, a speech-to-text processing of audio content from the video content, the speech-to-text processing resulting in a transcript, and creating at least part of the metadata repository using the script and the transcript. The method may further comprise aligning, using the computer system, portions of the script with matching portions of the transcript, forming a script-transcript alignment, wherein the script-transcript alignment is used in creating at least one entry for the metadata repository. The method may further comprise, before performing the search, performing an object recognition process on the video content, the object recognition process identifying at least one object in the video content, and creating at least one entry in the metadata repository that associates the object with at least one frame in the video content.

The method may further comprise, before performing the search, performing an audio recognition process on an audio portion of the video content, the audio recognition process identifying at least one sound in the video content as being generated by a sound source, and creating at least one entry in the metadata repository that associates the sound source with at least one frame in the video content. The method may further comprise, before performing the search, identifying at least one term as being associated with the video content, expanding the identified term into an expanded term set, and creating at least one entry in the metadata repository that associates the expanded term set with at least one frame in the video content.

In a second aspect, a computer program product is tangibly embodied in a computer-readable storage medium and comprises instructions that when executed by a processor perform a method comprises receiving, in a computer system, a user query comprising at least a first term, parsing the user query to at least determine whether the user query assigns a field to the first term, the parsing resulting in a parsed query that conforms to a predefined format, performing a search in a metadata repository using the parsed query, the metadata repository embodied in a computer readable medium and being generated based on multiple modes of metadata for video content, the search identifying a set of candidate scenes from the video content, ranking the set of candidate scenes according to a scoring metric into a ranked scene list, and generating an output from the computer system that includes at least part of the ranked scene list, the output generated in response to the user query.

In a third aspect, a computer system comprises a metadata repository embodied in a computer readable medium and being generated based on multiple modes of metadata for video content, a multimodal query engine embodied in a computer readable medium and configured for searching the metadata repository based on a user query, the multimodal query engine comprising a parser configured to parse the user query to at least determine whether the user query assigns a field to the first term, the parsing resulting in a parsed query that conforms to a predefined format, a scene searcher configured to perform a search in the metadata repository using the parsed query, the search identifying a set of candidate scenes from the video content, and a scene scorer configured to rank the set of candidate scenes according to a scoring metric into a ranked scene list, and a user interface embodied in a computer readable medium and configured to receive the user query from a user and generate an output that includes at least part of the ranked scene list in response to the user query.

Implementations can include any, all or none of the following features. The parser may further comprise an expander expanding the first term so that the user query includes at least also a second term related to the first term. The parser may further comprise a disambiguator disambiguating any of the first and second terms that has multiple meanings

Particular embodiments of the subject matter described in this specification can be implemented to realize one or more of the following advantages. Access to media data such as audio and/or video can be improved. An improved query engine for searching video and audio data can be provided. The query engine can allow searching of video contents for features such as characters, dialog, entities and/or objects occurring or being implied in the video. A system for managing media data can be provided with improved searching functions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a block diagram example of an example of a multimodal search engine system.

FIG. 2 shows a block diagram example of a multimodal query engine workflow.

FIG. 3 is a flow diagram of an example method of processing multimodal search queries.

Like reference numbers and designations in the various drawings indicate like elements.

### DETAILED DESCRIPTION

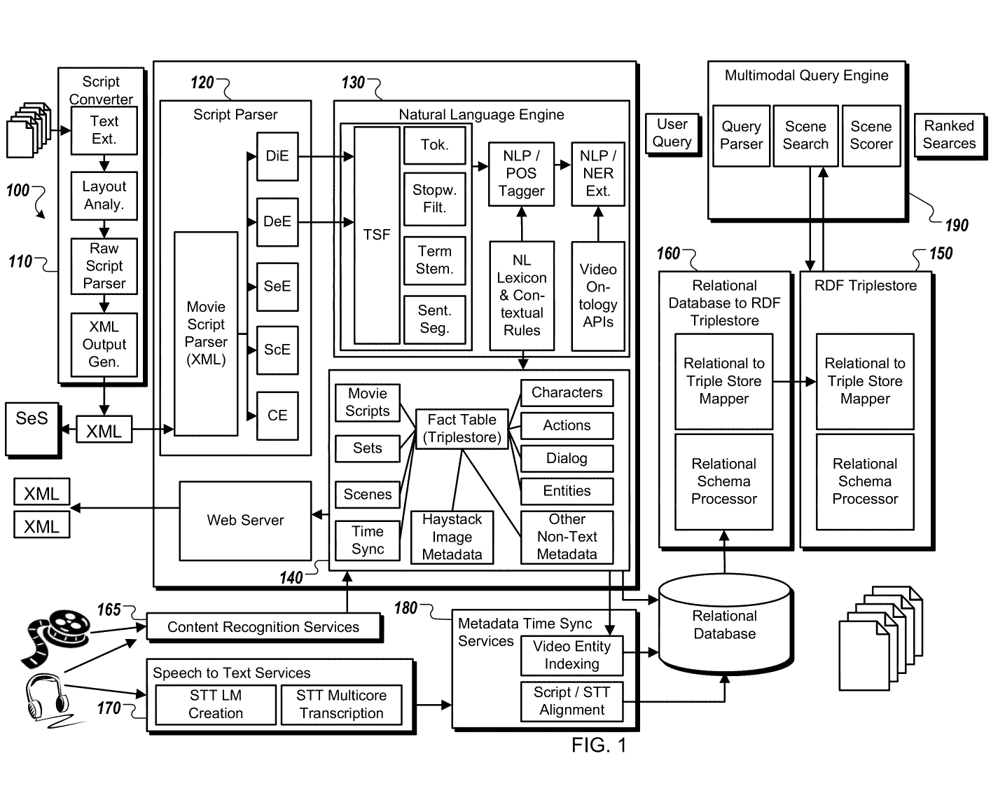

FIG. 1 shows a block diagram example of a multimodal search engine system 100. In general, the system 100 includes a number of related sub-systems that when used in aggregate, provide users with useful functions for understanding and leveraging multimodal media (such as video, audio, and/or text contents) to address a wide variety of user requirements. In some implementations, the system 100 may capture, convert, analyze, store, synchronize, and search multimodal content. For example, video, audio, and script documents may be processed within a workflow in order to enable the creation of the script editing with metadata capture, script alignment, and search engine optimization (SEO). In FIG. 1, example elements of the processing workflow are shown, along with some created end product features.

Input is provided for movie script documents, closed caption data, and/or source transcripts, such that they can be processed by the system 100. In some implementations, the movie scripts are formatted using a semi-structured specification format (e.g., the “Hollywood Spec” format) which provides descriptions of some or all scenes, actions, and dialog events within a movie. The movie scripts can be used for subsequent script analysis, alignment, and multimodal search subsystems, to name a few examples.

A script converter 110 is included to capture movie and/or television scripts (e.g., “Hollywood Movie” or “Television Spec” scripts). In some implementations, script elements are systematically extracted from scripts by the script converter 110 and converted into a structured format. This may allow script elements (e.g., scenes, shots, action, characters, dialog, parentheticals, camera transitions) to be accessible as metadata to other applications, such as those that provide indexing, searching, and organization of video by textual content. The script converter 110 may capture scripts from a wide variety of sources, for example, from professional screenwriters using word processing or script writing tools, from fan-transcribed scripts of film and television content, and from legacy script archives captured by optical character recognition (OCR).

Scripts captured and converted into a structured format are parsed by a script parser 120 to identify and tag script elements such as scenes, actions, camera transitions, dialog, and parentheticals. The script parser 120 can use a movie script parser for such operations, which can make use of a markup language such as XML. In some implementations, this ability to capture, analyze, and generate structured movie scripts may be used by time-alignment workflows where dialog text within a movie script may be automatically synchronized to the audio dialog portion of video content. For example, the script parser 120 can include one or more components designed for dialog extraction (DiE), description extraction (DeE), set and/or setup extraction (SeE), scene extraction (ScE), or character extraction (CE).

A natural language engine 130 is used to analyze dialog and action text from the input script documents. The input text is normalized and then broken into individual sentences for further processing. For example, the incoming text can be processed using a text stream filter (TSF) to remove words that are not useful and/or helpful in further processing of media data. In some implementations, the filtering can involve tokenization, stop word filtering, term stemming, and/or sentence segmentation. A specialized part-of-speech (POS) tagger is used to parse, identify, and tag the grammatical units of each sentence with its part-of-speech (e.g., noun, verb, article, etc.) In some implementations, the POS tagger may use a transformational grammar technique to induce and learn a set of lexical and contextual grammar rules for performing the POS tagging step.

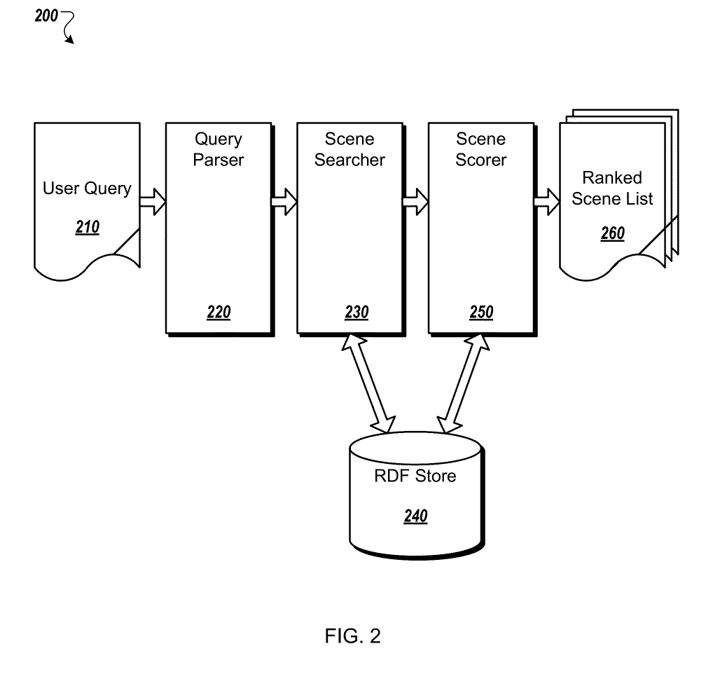

Tagged verb and noun phrases are submitted to a Named Entity Recognition (NER) extractor which identifies and classifies entities and actions within each verb or noun phrase. In some implementations, the NER extractor may use one or more external world-knowledge ontologies to perform entity tagging and classification, and the NLE 130 can use appropriate application programming interfaces (API) for this and/or other purposes. In some implementations, the natural language engine 130 can include a term expander and disambiguator. For example, the term expander and disambiguator can be a module that searches dictionaries, encyclopedias, Internet information sources, and/or other public or private repositories of information, to determine synonyms, hypernyms, holonyms, meronyms, and homonyms, for words identified within the input script documents. Examples of using term expanders and disambiguators are discussed in the description of FIG. 2.

Entities extracted by the NER extractor are then represented in a script entity-relationship (E-R) data model 140. Such a data model can include scripts, movie sets, scenes, actions, transitions, characters, parentheticals, dialog, and/or other entities, and these represented entities are physically stored into a relational database. In some implementations, represented entities stored in the relational database are processed to create a resource description framework (RDF) triplestore 150. In some implementations, the represented entities can be processed to create the RDF triplestore 150 directly.

A relational to RDF mapping processor 160 processes the relational database schema representation of the E-R data model 140 to transfer relational database table rows into the RDF triplestore 150. In the RDF triplestore 150, queries or other searches can be performed to find video scene entities, for example. The RDF triplestore can include triplets of subject, predicate and object, and may be queried using and RDF query language such as the one known as SPARQL. In some implementations, the triplets can be generated based on multiple modes of metadata for the video and/or audio content. For example, the script converter 110 and the STT services 170 (FIG. 1) can generate metadata independently or collectively that can be used in specifying respective subjects, predicates and objects for triplets so that they describe the media content.

Thus, the RDF triplestore 150 can be used to store the mapped relational database using the relational to RDF mapping processor 160. A web-server and workflow engine in the system 100 can be used to communicate RDF triplestore data back to client applications such as a story script editing service. In some implementations, the story script editing service may be a process that can leverage this workflow and the components described herein to provide script writers with tools and functions for editing and collaborating on movie scripts, and to extract, index, and tag script entities such as people, places, and objects mentioned in the dialog and action sections of a script.

Input video content provides video footage and dialog sound tracks to be analyzed and later searched by the system 100. A content recognition services module 165 processes the video footage and/or audio content to create metadata that describes persons, places, and things in the video. In some implementations, the content recognition services module 165 may perform face recognition to determine when various actors or characters appear onscreen. For example, the content recognition services module 165 may create metadata that describes when “Bruce Campbell” or “Yoda” appear within the video footage. In some implementations, the content recognition services module 165 can perform object recognition. For example, the content recognition services module 165 may identify the presence of a dog, a cell phone, or the Eiffel Tower in a scene of a video, and associate metadata keywords such as “dog,” “cell phone,” or “Eiffel Tower” with a corresponding scene number, time stamp, or duration, or may otherwise associate the recognized objects with the video or subsection of the video. The metadata produced by the content recognition services module 165 can be represented in the E-R data model 140.

In some implementations, input audio dialog tracks may be provided by studios or extracted from videos. A speech to text (STT) services module 170 here includes an STT language model component that creates custom language models to improve the speech to text transcription process in generating text transcripts of source audio. The STT services module 170 here also includes an STT multicore transcription engine that can employ multicore and multithread processing to produce STT transcripts at a performance rate faster than that which may be obtained by single threaded or single processor methods.

The STT services module 170 can operate in conjunction with a metadata time synchronization services module 180. Here the time synchronization services module 180 employs a modified Viterbi time-alignment algorithm using a dynamic programming method to compute STT/script word submatrix alignment. The time synchronization services module 180 can also include a module that performs script alignment using a two-stage script/STT word alignment process resulting in scripts elements each assigned an accurate time-code. For example, this can facilitate time code and timeline searching by the multimodal video search engine.

In some implementations, the content recognition services module 165 and the STT services module 170 can be used to identify events within the video footage. By aligning the detected sounds with information provided by the script, the sounds may be identified. For example, and unknown sound may be detected just before the STT services module identifies an utterance of the word “hello”. By determining the position of the word “hello” in the script, the sound may also be identified. For example, the script may say “telephone rings” just before a line of dialog where an actor says “Hello?”

In another implementation, the content recognition services module 165 and the STT services module 170 can be used cooperatively to identify events within the video footage. For example, the video footage may contain a scene of a car explosion followed by a reporter taking flash photos of the commotion. The content recognition services module 165 may detect a very bright flash within the video (e.g., a fireball), followed by a series of lesser flashes (e.g. flashbulbs), while the STT services module 170 detects a loud noise (e.g., the bang), followed by a series of softer sounds (e.g., cameras snapping) on substantially the same time basis. The video and audio metadata can then be aligned with descriptions within the script (e.g., “car explodes”, “Jimmy quickly snaps a series of photos”) to identify the nature of the visible and audible events, and create metadata information that describes the events' locations within the video footage.

In some implementations, the content recognition services module 165 and the STT services module 170 can be used to identify transitions between scenes in the video. For example, the content recognition services module 165 may generate scene segmentation point metadata by detecting significant changes in color, texture, lighting, or other changes in the video content. In another example, the STT services module 170 may generate scene segmentation point metadata by detecting changes in the characteristics of the audio tracks associated with the video content. For example, changes in ambient noise may imply a change of scene. Similarly, passages of video accompanied by musical passages, explosions, repeating sounds (e.g., klaxons, sonar pings, heartbeats, hospital monitor bleeps), or other sounds may be identified as scenes delimited by starting and ending timestamps.

In some implementations, the metadata time sync services module 180 can use scene segmentation point metadata. For example, scene start and end points detected within a video may be aligned with scenes as described in the video's script to better align subsections of the audio tracks during the script/STT word alignment process.

In some implementations, software applications may be able to present a visual representation of the source script dialog words time-aligned with video action.

The system 100 also includes a multimodal video search engine 190 that can be used for querying the RDF triplestore 150. In other implementations, the multimodal video search engine 190 can be included in a system that includes only some, or none, of the other components shown in the exemplary system 100. Examples of the multimodal query engine 190 will be discussed in the description of FIG. 2.

FIG. 2 shows a block diagram example of a multimodal query engine workflow 200. In general, the multimodal query engine architecture 200 can support indexing and search over video assets. In some implementations, the multimodal query engine workflow 200 may provide functions for content discovery (e.g., fine grained search and organization), content understanding (e.g., semantics and contextual advertising), and/or leveraging of the metadata collected as part of a production workflow.

In some implementations, the multimodal query engine workflow 200 can be used to prevent or alleviate problems such as terse descriptions leading to vocabulary mismatches, and/or noisy or error prone metadata causing ambiguities within a text or uncertain feature identification.

Overall, the multimodal query engine workflow 200 includes steps for query parsing (e.g., to analyze semi-structured text), scene searching (e.g., filtering list of scenes), and scene scoring (e.g., ranking scene against query fields). In some implementations, multiple layers of processing, each designed to be configurable depending on desired semantics, may be implemented to carry out the workflow 200. In some implementations, distributed or parallel processing may be used. In some implementations, the underlying data stores may be located on multiple machines.

A user query 210 is input from the user, for example as semi-structured text. In some implementations, the workflow 200 may support various types of requests such as requests for characters (e.g., the occurrence of a action particular character, having a specific name, in a video), requests for dialog (e.g., words spoken in dialog), requests for actions (e.g., descriptions of on-screen events, objects, setting, appearance), requests for entities (e.g., objects stated or implied by either the action or in the dialog), requests for locations, or other types of requests of information that describes video content.

For example, the user may wish to search one or more videos for scenes where a character ‘Ross’ appears, and that bear some relation to coffee. In an illustrative example, such a user query 210 can include query features such as “char=Ross” and “entity=coffee”. In another example, the user query 210 may be “dialog=‘good morning Vietnam’” to search for videos where “good morning Vietnam” occurs in the dialog. As another example, a search can be entered for a video that includes a character named “Munny” and that involves the action of a gunfight, and such a query can include “char=Munny” and “action=‘gunfight’.”

A query parser 220 converts the user query 210 into a well-formed, typed query. For example, the query parser 220 can recognize query attributes, such as “char” and “entity” in the above example. In some implementations, the query parser 220 may normalize the query text through tokenization and filtering steps, case folding, punctuation removal, stopword elimination, stemming, or other techniques. In some implementations, the query parser may perform textual expansion of the user query 210 using the natural language engine 130 or a web-based term expander and disambiguator.

The query parser 220 can include a term expander and disambiguator. In some implementations, the term expander and disambiguator obtains online search results and performs logical expansion of terms into a set of related terms. In some implementations, the term expander and disambiguator may address the problems of vocabulary mismatches (e.g., the author writes “pistol” but user queries on the term “gun”), disambiguation of content (e.g., to determine if a query for “diamond” means an expensive piece of carbon or a baseball field), or other such sources of ambiguity in video scripts, descriptions, or user terminology.

The term expander and disambiguator can access information provided by various repositories to perform the aforementioned functions. For example, the term expander and disambiguator can be web-based and may use web search results (e.g., documents matching query terms may be likely to contain other related terms) in performing expansion and/or disambiguation. In another example, the web-based term expander and disambiguator may use a lexical database service (e.g., WordNet) that provides a searchable library of synonyms, hypernyms, holonyms, meronyms, and homonyms that the web-based term expander and disambiguator may use to clarify the user's intent. Other example sources of information that the web-based term expander and disambiguator may use include hyperlinked knowledge bases such as Wikipedia and Wiktionary. By using such Internet/web search results, the web-based term expander and disambiguator can perform sense disambiguation of the user query 210.

In an example of using the term expander and disambiguator, the user query 210 may include “char=Ross” and “entity=coffee”. The term expander and disambiguator may process the user query 210 to provide a search query of

“‘char’:‘ross’, ‘entity’: [‘coffee’, ‘tea’, ‘starbucks’, ‘mug’, ‘caffeine’, ‘drink’, ‘espresso’, ‘water’]”

In some implementations, the term expander and disambiguator may expand one or more terms by issuing the query to a commonly available search engine. For example, the term “coffee” may be submitted to the search engine, and the search engine may return search hits for “coffee” on Wikipedia, a coffee company called “Green Mountain Roasters”, and a company doing business under the name “CoffeeForLess.com”. The Wikipedia page may include information on the plant producing this beverage, its history, biology, cultivation, processing, social aspects, health aspects, economic impact, or other related information. The Green Mountain Roasters web page may provide test that describes how users can shop online for signature blends, specialty roasts, k-cup coffee, seasonal flavors, organic offerings, single cup brews, decaffeinated coffees, gifts, accessories, and more. The CoffeeForLess web site may provide text such as “Search our wide selection of Coffee, Tea, and Gifts—perfect for any occasion—free shipping on orders over $150—serving businesses since 1975.”

The term expander and disambiguator may analyze the textual content of these or other web pages and compute statistics over the text of the resulting page abstracts. For example, statistics can relate to occurrence or frequency of use for particular terms in the obtained results, and/or on other metrics of distribution or usage. An example table of such statistics is shown in Table 1.

TABLE 1

| | |
|---|---|
| coffee | 108.122306 |
| coffee bean | 53.040302 |
| bean | 45.064262 |
| espresso | 38.62651 |
| roast | 36.574339 |
| caffeine | 35.208207 |
| cup | 33.760929 |
| flavor | 31.296184 |
| tea | 28.969882 |
| beverage | 27.384161 |
| cup coffee | 25.751007 |
| brew | 25.751007 |
| coffee maker | 25.751007 |
| fair trade | 23.472138 |
| taste | 23.472138 |

In some implementations, the term expander and disambiguator may use web search results to address ambiguity that may exist among individual terms. For example, searching may determine that the noun “java” has at least three senses. In a first sense, “Java” may be an island in Indonesia to the south of Borneo; one of the world's most densely populated regions. In a second sense, “java” may be coffee, a beverage consisting of an infusion of ground coffee beans; as in “he ordered a cup of coffee”. And in a third sense, “Java” may be a platform-independent object-oriented programming language.

In some implementations, the technique for disambiguating terms of the user query 210 may include submitting a context vector V as a query to a search engine. For example, the context vector V can be generated based on a context of the user query 210, such as based on information about the user and/or on information in the user query 210. The context vector V is then submitted to one or more search engines and results are obtained, such as in form of abstracts of documents responsive to the V-vector query. Appended abstracts can then be used to form a vector V′.

Each identified word sense (e.g., the three senses of “java”) may then be expanded using semantic relations (e.g., hypernyms, hyponyms), and these expansions are referred to as S₁, S₂, and S₃, respectively, or Sᵢ collectively. Each expansion may then be submitted as a query to the search engine, forming a corresponding result vector Sᵢ′. A correlation between the appended abstract vector V′ and each of the expanded terms vectors Si′ is then determined. For example, the relative occurrences or usage frequencies of particular terms in V′ and Si′ can be determined. Of the multiple senses, the one with the greatest correlation to the vector V′ can then be selected to be the sense that the user most likely had in mind. In mathematical terms, the determination may be expressed as:

sense i←ARGMAX(sim(V′, Si')),

where sim( ) represents a similarity metric that takes the respective vectors as arguments. Thus, terms in the user query can be expanded and/or disambiguated, for example to improve the quality of search results.

In some implementations, character names may be excluded from term expansion and/or disambiguation. For example, the term “heather” may be expanded to obtain related terms such as “flower”, “ericaceae”, or “purple”. However, if a character within a video is known to be named “Heather” (e.g., from a cast of characters provided by the script), then expansion and/or disambiguation may be skipped.

A scene searcher 230 executes the user query 210, as modified by the query parser 220, by accessing an RDF store 240 and identifying candidate scenes for the user query 210. In some implementations, the scene searcher 230 may improve performance by filtering out non-matching scenes. In some implementations, SPARQL predicate order may be taken into account as it may influence performance. In some implementations, the scene searcher 230 may use knowledge of selectivity of query fields when available.

The scene searcher may employ any of a number of different search types. For example, the scene searcher 230 may a general search, wherein all scenes may be searched. In another example, the scene searcher 230 may implement a Boolean search, wherein scenes which match all of the individual query fields may be searched. For example, for a query of

“‘char’: ‘ross’, ‘entity’: [‘coffee’, ‘tea’, ‘starbucks’, ‘mug’, ‘caffeine’, ‘drink’, ‘espresso’]”

the scene searcher 230 may return a response such as

“[Scene A, Scene B, Scene C, Scene D, . . . ]”

wherein the media contents resulting from the query are listed in the response. Such a collection or list of scenes that presumably are relevant to the user's query is here referred to as a candidate scene set.

A scene scorer 250 provides ranked lists of scenes 260 in response to the given user query 210 and candidate scene set. In some implementations, the scene scorer 250 may use knowledge of semantics of query fields for scoring scenes. In some implementations, numerous similarity metrics and weighting schemes may be possible. For example, the scene scorer 250 may use Boolean scoring, vector space modeling, term weighting (e.g., tf-idf), similarity metrics (e.g., cosine), semantic indexing (e.g., LSA), graph based techniques(e.g., SimRank), multimodal data sources, and/or other metrics and schemes to score a scene based on the user query 210. In some examples, the similarity metrics and weighting schemes may include confidence scores.

In some implementations, additional optimizations may be implemented. For example, Fagin's algorithm, described in Ronald Fagin et al., Optimal aggregation algorithms for middleware, 66 Journal of Computer and System Sciences 614-656 (2003) may be used.

In one example, the scene scorer 250 may respond to the example query,

“‘char’: ‘ross’, ‘entity’: [‘coffee’, ‘tea’, ‘starbucks’, ‘mug’, ‘caffeine’, ‘drink’, ‘espresso’],

which resulted in the candidate scene set

[Scene_A, Scene_B, Scene_C, Scene_D],”

by providing an ordered list that includes indications of scenes and scores, ranked by score value. For example, the scene scorer 250 may return a response of

“[Scene_B: 0.754, Scene_D: 0.638, Scene_C: 0.565, Scene_A: 0.219].

The ranked scene list 260 can then be presented, for example to the user who initiated the query. In some implementations, the ranked scene list 260 is presented in a graphical user interface with interactive technology, such that the user can select any or all of the results and initiate playing, for example by a media player.

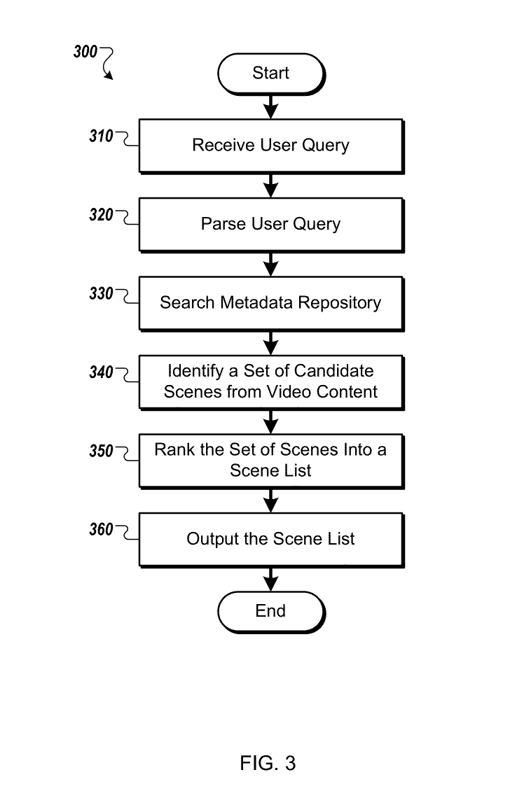

FIG. 3 is a flow diagram of an example method 300 of processing multimodal search queries. The method can be performed by a processor executing instructions stored in a computer-readable storage medium, such as in the system 100 in FIG. 1.

The method 300 includes a step 310 of receiving, in a computer system, a user query comprising at least a first term. For example, the user query 210 (FIG. 2) containing at least “char=Ross” can be received.

The method 300 includes a step 320 of parsing the user query to at least determine whether the user query assigns a field to the first term, the parsing resulting in a parsed query that conforms to a predefined format. For example, the query parser 220 (FIG. 2) can parse the user query 210 and recognize “char” as a field to be used in the query.

The method 300 includes a step 330 of performing a search in a metadata repository using the parsed query. The metadata repository is embodied in a computer readable medium and includes triplets generated based on multiple modes of metadata for video content. For example, the scene searcher 230 (FIG. 2) can search the RDF store 240 for triplets that match the user query 210.

The method 300 includes a step 340 of identifying a set of candidate scenes from the video content. For example, the scene searcher 230 can collect identifiers for the matching scenes and compile a candidate scene set.

The method 300 includes a step 350 of ranking the set of candidate scenes according to a scoring metric into a ranked scene list. For example, the scene scorer 250 (FIG. 2) can rank the search results obtained from the scene searcher 230 and generate the ranked scene list 260.

The method 300 includes a step 360 of generating an output from the computer system that includes at least part of the ranked scene list, the output generated in response to the user query. For example, the system 100 (FIG. 1) can display the ranked scene list 260 (FIG. 2) to one or more users.

Some portions of the detailed description are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, a blu-ray player, a television, a set-top box, or other digital devices.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, an infrared (IR) remote, a radio frequency (RF) remote, or other input device by which the user can provide input to the computer. Inputs such as, but not limited to network commands or telnet commands can be received. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
tagging, in dialog and action text from an input script document regarding video content, at least some grammatical units of each sentence according to part-of-speech to generate tagged verb and noun phrases;
submitting the tagged verb and noun phrases to a named entity recognition (NER) extractor;
identifying and classifying, by the NER extractor, entities and actions in the tagged verb and noun phrases, the NER extractor using one or more external world knowledge ontologies in performing the identification and classification;
generating an entity-relationship data model that represents the entities and actions identified and classified by the NER extractor;
processing the generated entity-relationship data model to generate a metadata repository;
receiving, in a computer system, a user query comprising at least a first term;
parsing the user query to at least determine whether the user query assigns an action field defining the first term, the action field being a description of an action performed by an entity in a video;
converting the user query into a parsed query that conforms to a predefined format;
performing a search in the metadata repository using the parsed query, the metadata repository embodied in a computer readable medium and being generated based on multiple modes of metadata for the video content, the search identifying a set of candidate scenes from the video content;
ranking the set of candidate scenes according to a scoring metric into a ranked scene list; and
generating an output from the computer system that includes at least part of the ranked scene list, the output generated in response to the user query.

2. The method of claim 1, wherein the parsing further comprises determining whether the user query assigns at least any of the following fields to the first term:
a character field defining the first term to be a name of a video character;
a dialog field defining the first term to be a word included in video dialog; or
an entity field defining the first term to be an object stated or implied by a video.

3. The method of claim 1, wherein the parsing comprises:
tokenizing the user query:
expanding the first term so that the user query includes at least a second term related to the first term; and
disambiguating any of the first and second terms that has multiple meanings.

4. The method of claim 3, wherein expanding the first term comprises:
performing an online search using the first term and identifying the second term using the online search;
obtaining the second term from an electronic dictionary of related words; or
obtaining the second term by accessing a hyperlinked knowledge base using the first term.

5. The method of claim 4, wherein performing the online search comprises:
entering the first term in an online search engine;
receiving a search result from the online search engine for the first term;
computing statistics of word occurrences in the search results; and
selecting the second term from the search result based on the statistics.

6. The method of claim 4, wherein disambiguating any of the first and second terms comprises:
obtaining information from the online search that defines the multiple meanings;
selecting one meaning of the multiple meanings using the information; and
selecting the second term based on the selected meaning.

7. The method of claim 6, wherein selecting the one meaning comprises:
generating a context vector that indicates a context for the user query;
entering the context vector in the online search engine and obtaining context results;
expanding terms in the information for each of the multiple meanings, forming expanded meaning sets;
entering each of the expanded meaning sets in the online search engine and obtaining corresponding expanded meaning results; and
identifying one expended meaning result from the expanded meaning results that has a highest similarity with the context results.

8. The method of claim 1, wherein performing the search in the metadata repository comprises:
accessing the metadata repository and identifying a matching set of scenes that match the parsed query; and
filtering out at least some scenes of the matching set, a remainder of the matching set forming the set of candidate scenes.

9. The method of claim 8, wherein the metadata repository includes triples formed by associating selected subjects, predicates and objects with each other, and wherein the method further comprises:
optimizing a predicate order in the parsed query before performing the search in the metadata repository.

10. The method of claim 8, further comprising:
determining a selectivity of multiple fields with regard to searching the metadata repository; and
performing the search in the metadata repository based on the selectivity.

11. The method of claim 8, wherein the parsed query includes multiple terms assigned to respective fields, and wherein the search in the metadata repository is performed such that the set of candidate scenes match all of the fields in the parsed query.

12. The method of claim 1, the method further comprising, before performing the search:
receiving, in the computer system, a script used in production of the video content, the script including at least dialog for the video content and descriptions of actions performed in the video content;
performing, in the computer system, a speech-to-text processing of audio content from the video content, the speech-to-text processing resulting in a transcript; and
creating at least part of the metadata repository using the script and the transcript.

13. The method of claim 12, further comprising:
aligning, using the computer system, portions of the script with matching portions of the transcript, forming a script-transcript alignment, the script-transcript alignment being used in creating at least one entry for the metadata repository.

14. The method of claim 1, the method further comprising, before performing the search:
performing an object recognition process on the video content, the object recognition process identifying at least one object in the video content; and
creating at least one entry in the metadata repository that associates the object with at least one frame in the video content.

15. The method of claim 1, the method further comprising, before performing the search:
performing an audio recognition process on an audio portion of the video content, the audio recognition process identifying at least one sound in the video content as being generated by a sound source; and
creating at least one entry in the metadata repository that associates the sound source with at least one frame in the video content.

16. The method of claim 1, the method further comprising, before performing the search:
identifying at least one term as being associated with the video content;
expanding the identified term into an expanded term set; and
creating at least one entry in the metadata repository that associates the expanded term set with at least one frame in the video content.

17. A computer program product tangibly embodied in a computer-readable storage medium and comprising instructions executable by a processor to perform a method comprising:
tagging, in dialog and action text from an input script document regarding video content, at least some grammatical units of each sentence according to part-of-speech to generate tagged verb and noun phrases;
identifying and classifying, by the named entity recognition (NER) extractor, entities and actions in the tagged verb and noun phrases, the NER extractor using one or more external world knowledge ontologies in performing the identification and classification;
generating an entity-relationship data model that represents the entities and actions identified and classified by the NER extractor;
processing the generated entity-relationship data model to generate a metadata repository;
receiving, in a computer system, a user query comprising at least a first term;
parsing the user query to at least determine whether the user query assigns an action field defining the first term, the action field being a description of an action performed by an entity in a video;
converting the user query into a parsed query that conforms to a predefined format;
performing a search in the metadata repository using the parsed query, the metadata repository embodied in a computer readable medium and being generated based on multiple modes of metadata for the video content, the search identifying a set of candidate scenes from the video content;
ranking the set of candidate scenes according to a scoring metric into a ranked scene list; and
generating an output from the computer system that includes at least part of the ranked scene list, the output generated in response to the user query.

18. A computer system comprising:
a metadata repository embodied in a computer readable medium and being generated based on multiple modes of metadata for video content, including:
tagging, in dialog and action text from an input script document regarding video content, at least some grammatical units of each sentence according to part-of-speech to generate tagged verb and noun phrases;
submitting the tagged verb and noun phrases to a named entity recognition (NER) extractor;
identifying and classifying, by the NER extractor, entities and actions in the tagged verb and noun phrases, the NER extractor using one or more external world knowledge ontologies in performing the identification and classification;
generating an entity-relationship data model that represents the entities and actions identified and classified by the NER extractor; and
processing the generated entity-relationship data model to generate a metadata repository;
a multimodal query engine embodied in a computer readable medium and configured for searching the metadata repository based on a user query, the multimodal query engine comprising:
a parser configured to parse the user query to at least determine whether the user query assigns an action field defining the first term, the action field being a description of an action performed by an entity in a video;
converting the user query into a parsed query that conforms to a predefined format;
a scene searcher configured to perform a search in the metadata repository using the parsed query, the search identifying a set of candidate scenes from the video content; and
a scene scorer configured to rank the set of candidate scenes according to a scoring metric into a ranked scene list; and
a user interface embodied in a computer readable medium and configured to receive the user query from a user and generate an output that includes at least part of the ranked scene list in response to the user query.

19. The computer system of claim 18, wherein the parser further comprises:
an expander expanding the first term so that the user query includes at least also a second term related to the first term.

20. The computer system of claim 19, wherein the parser further comprises:
a disambiguator disambiguating any of the first and second terms that has multiple meanings.
